(19) United States
(12) Patent Application Publication
(10) Pub. No.: US 2024/0362145 A1
(43) Pub. Date: Oct. 31, 2024

(54) METHODS AND SYSTEMS FOR MANAGING LATENCY IN DATA PROCESSING SYSTEMS

(71) Applicant: Dell Products L.P., Round Rock, TX (US)

(72) Inventors: OFIR EZRIELEV, Be'er Sheva (IL); TOMER KUSHNIR, Omer (IL); MAXIM BALIN, Gan-Yavne (IL)

(21) Appl. No.: 18/309,254

(22) Filed: Apr. 28, 2023

(51) Int. Cl. G06F 11/34; G06F 11/07

(52) U.S. Cl. CPC G06F 11/3457; G06F 11/0793

(57) ABSTRACT

Methods and systems for managing data processing systems are disclosed. The data processing systems may be managed through identification and remediation of latency discrepancies on the data processing systems. The identification of latency discrepancies on data processing systems is facilitated by monitoring latency in execution of real-world devices on data processing systems and comparing to model prediction of latency of the devices. Execution of the devices and model prediction may utilize the same application pathway. In utilizing the same application pathway, the source of latency affecting the real-world device, called the negative communications modifier, may be isolated.

### FIELD

Embodiments disclosed herein relate generally to device management. More particularly, embodiments disclosed herein relate to managing devices using security models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIG. 2A shows a first data flow diagram illustrating operation of a portion of a system in accordance with an embodiment.

FIG. 2B shows a second data flow diagram illustrating operation of a portion of a system in accordance with an embodiment.

FIG. 2C shows a third data flow diagram illustrating operation of a portion of a system in accordance with an embodiment.

FIGS. 3A-3B show flow diagrams illustrating a method of making a determination of the presence of a negative communications modifier.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to the methods and systems for managing latency in data processing systems. The data processing systems may be managed through identification and remediation of latency discrepancies on the data processing systems.

In the identification of latency discrepancies, latency may be monitored in a device that may be used by a data processing system. The device may utilize one of many application pathways to run a command. The latency of the device may vary by changing the application pathway utilized in running a command. The application pathway may be a set of chained applications, along which the output of one application may be the input for another application. The set of chained applications may vary in the arrangement of applications. Therefore, the latency of a device may vary in the arrangement of applications that may comprise the set of chained applications.

In consideration of the sources of latency in a device, the problem scale associated with directly measuring all possible arrangements of applications for the set of chained applications may be intractable. Therefore, a more feasible solution may involve the modeling of latency data for all possible arrangements of applications for the set of chained applications. Latency data for all possible arrangements of the set of chained applications may be acquired through simulation of a digital representation of the device that may run the command. Through simulating the digital representation of the device, an inference model may be trained that may predict latency based on selection of an application pathway.

With an inference model that may predict latency based on selection of an application pathway, comparison of latency data may be facilitated with latency measured from a device that utilizes a predetermined application pathway. Given latency data between prediction by the inference model and execution by the device, a comparison may be made. If the latency data from the inference model and the device may be similar within a predetermined latency threshold, then the latency data may be said to match. However, if the latency data from the inference model and the device may not be similar within a predetermined latency threshold, then a negative discrepancy may exist between the inference model and the device. If a negative discrepancy may exist between the inference model and the device, the source of the negative discrepancy, which may be known as a negative communications modifier, may require identification. Once the negative communications modifier may be identified, an action set may be performed on the device to remediate the negative communications modifier.

In an embodiment, a method for managing a deployment is provided. The method may include obtaining first data regarding operation of a set of chained applications in a device of the deployment, the set of chained applications using at least one real-world transaction in the operation of the set of chained applications; obtaining second data regarding simulated operation of the set of chained applications from an inference model, the inference model generating predictions for the simulated operation of the set of chained application; making a determination regarding whether a negative communications modifier existing in the deployment based on the first data and the second data; in a first instance of the determination where the negative communication modifier exists, performing an action set to attempt to remediate an impact of the negative communication modifier on the deployment; and, in a second instance of the determination where the negative communication modifier does not exist: maintaining operation of the deployment to provide computer implemented services.

Prior to obtaining the first data and the second data, the method may include obtaining a digital twin model for the deployment, the digital twin model being adapted to replicate the operation of the set of chained applications of the deployment in a digital environment; obtaining the inference model for the deployment using the digital twin model; and deploying the inference model to the deployment to manage the deployment.

Obtaining the inference model may include identifying a type of inference model based on applications of the deployment that are chained together to obtain the set of chained applications; and generating an instance of the type of the inference model.

Identifying the type of inference model may include identifying the set of applications in the inference model; identifying an input and output of each application in the set of applications; and setting the application pathways so that the output of one application can be the input of a valid type for another application.

Generating the instance of the type of inference model may include selecting a process that randomizes the pathways of the set of chained applications; identifying a set of first operations resulting from execution of the set of chained applications with the inference model that uses the randomized pathways; and obtaining training data based on the set of first operations of the set of chained applications.

Obtaining the first data regarding the operation of the set of chained applications may include identifying a duration of time for performance of the operation of the set of chained applications, the operation of the set of chained applications being defined by a pre-selected pathway of pathways through applications hosted by the deployment.

Obtaining the second data regarding simulated operation of the set of chained applications from the inference model may include ingesting the pre-selected pathway into the inference model to obtain a prediction for the duration of time for the performance of the operation of the set of chain applications.

Making the determination may include obtaining a latency threshold for the duration of time; performing a comparison of the duration of time and the predicted duration of time using the latency threshold; and, in an instance of the comparison where the duration of time exceeds the predicted duration of time and the latency threshold, identifying that a negative communication modifier exists.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

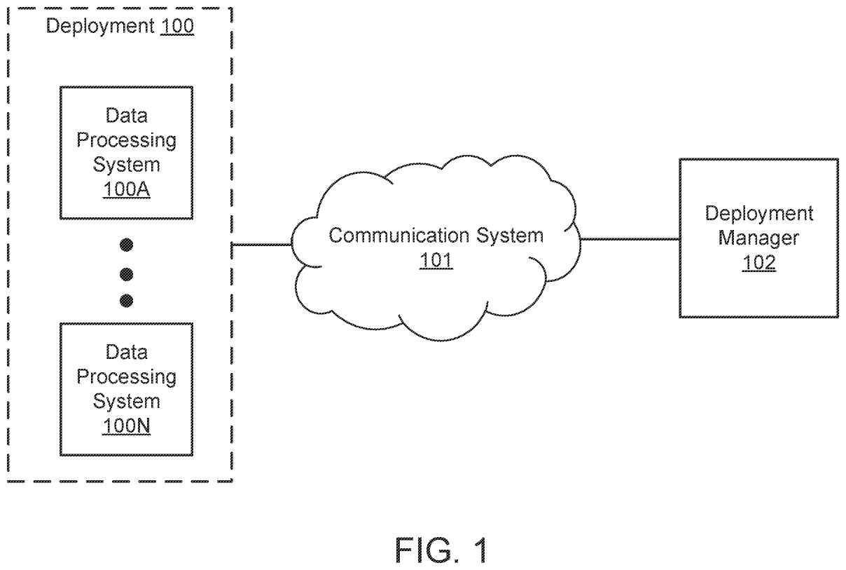

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, the system of FIG. 1 may include deployment 100. Deployment 100 may provide all or a portion of the computer-implemented services. To provide its functionality, deployment 100 may include any number of data processing system 100A-100N.

To provide the computer implemented services, any of data processing systems 100A-100N may operate based on commands that may be run with one or more applications. As one or more applications may be run on data processing systems 100A-100N, the set of applications to be run may be linked, or chained, together in such a way that the output of one application may be the input of another application. As the output of one application may be the input of another application, the transmission of data across the hardware of data processing systems 100A-100N may take place.

As data may be transmitted, latency, the time associated with the transmission of data, may become an important consideration. The transmission of data may become an important consideration with regard to user experience. In the transmission of data, upon execution of a command by data processing systems 100A-100N by the user, latency may increase with performance and therefore decrease with the quality of user experience. By these measures, high performance, and thus a high quality of user experience, of data processing systems 100A-100N may be associated with low latency. Therefore, an avenue through which performance and user experience of data processing systems 100A-100N may be augmented may be through the reduction of latency associated with the transmission of data.

Different varieties of latency may include, though not be limited to, mechanical latency, computer and operating system (COS) latency, and network latency. These types of latency may be similar in that they may be concerned with the time measurement of responsiveness of a system upon receiving an input signal. However, the responsiveness of the system may be dependent on conditions of the system which may regulate the time measurement of the responsiveness of the system.

Mechanical latency may refer to the time delay between an input signal and output signal due to physical effects that regulate the system. An example of this may involve an input signal, which is pressing a key on a typewriter, to produce an output signal, an inked character on a piece of paper. The time delay between both signals may depend on the mechanical processes associated with the key activating the inked ribbon which may strike the piece of paper. The time delay may be varied by changing mechanical characteristics of the typewriter. Mechanical characteristics that may be changed may include the depth of the keys to be pressed by the user and the position and angle of the inked ribbons from the piece of paper. Upon changing these characteristics of a typewriter, the time delay between pressing a key and imprinting an inked character may be varied. In variation of the time between pressing a key and imprinting a character, the mechanical latency of a typewriter may be altered. In altering the mechanical latency of the typewriter, the performance of and user experience with the typewriter may be altered as well. In altering the typewriter, for example, making the inked ribbons strike the piece of paper faster upon pressing a key, the typewriter may respond faster to input by a user. In responding faster to input by a user, the mechanical latency of a keyboard may be reduced. In reducing the mechanical latency of a keyboard, the performance of and user experience with the typewriter may be augmented.

Moving from a purely mechanical to computer-based standpoint, COS latency refers to the time delay between receiving the command input and obtainment of the desired output. Some examples include the time delay between (i) starting a new thread and execution of that thread, (ii) executing a thread lock to finish one process in a multi-threading scenario and then permitting another thread to run a process, and (iii) initiating a disk read from memory and having ready the memory for examination by the user. Implicit within these examples may be that multiple commands and processes may be executed between the input command and the desired output. As COS latency is a measure of time delay between an input command and desired output, COS latency may depend on multiple implicit commands and processes. Whatever implicit command and processes may be included within a COS latency measurement, one or more the processes may be modified to alter the COS latency.

Moving from a computer-based to network standpoint, network latency may be used to describe time delays over a network. As it may describe a time delay, network latency may be similar to other forms of latency in that it may describe a delay between an input signal, typically instantiation of a data packet, and a desired output, typically notification that the data packet has been received. As the transfer of a data packet may be involved, network latency may be caused altered by distance, website construction, end-user issues, and physical issues. Distance may be one of the main causes of network latency, as the transfer of data packet may take place over a variable distance. Typically, a data packet that may travel over one hundred miles may take less than twenty milliseconds. Conversely, a data packet that may travel over two thousand miles may take up to fifty milliseconds. Therefore, the latency of data packet travel may increase with the distance that a data packet may travel. Network latency may be present in the upon the loading of a webpage that may be accessed by a user on a network. Upon accessing the webpage, the content of the webpage may contain large data containments of images, audio, or video that may require download times greater than one second. In addition to large content that may be accessed by a webpage, third party content may be accessed by a webpage, a process that may further increase the network latency. To mitigate the network latency of these processes, network that hosts a webpage may benefit in having sufficient bandwidth capabilities to be able to move the necessary amount of data between the webpage and any third-party content websites. Further, an end-user accessing a webpage may benefit as well from sufficient bandwidth capabilities to be able to download large content from the webpage. When an accessing a webpage from another network, the end-user may be the source of network latency. Being the source of network latency, the end-user may have insufficient memory or low computer-processing unit (CPU) cycles to sufficiently load a webpage without significant delays. Aside from the end-user being the source of the network latency, the hardware of software components of a network may contribute to network latency. Hardware components of a network may include routers, switches, and wireless fidelity (Wi-Fi) access points. Software components of a network may include load balancers, security devices, and firewalls. Physical disturbances may also be a source of latency. For example, heavy rain, hurricanes, and stormy weather can disturb a wireless signal. Even buildings and vehicles may also block a signal, thereby increasing latency. As the source of network latency may include distance, website construction, end-user issues, and physical issues, numerous sources of network latency may exist, which may delay transfer of data to a client from a server.

As demonstrated in these examples, any mechanical, COS, or network device may be susceptible to latency between an input signal and desired output. As devices in these realms typically may be comprised of multiple components, the inherent source of latency may originate from one of many sources and may reside deep within the configuration of a device. Thus, identification of the source of latency may require a thorough investigation into the components of the device.

As they may contain hardware and software which may comprise and run the systems, data processing systems 100A-100N may be susceptible to mechanical, COS, or network latency. As data processing systems 100A-100N may be susceptible to mechanical, COS, or network latency, the source of the latency within data processing systems 100A-100N may be difficult to isolate as data processing systems 100A-100N may be comprised of multiple components. As one or more of the components may be susceptible to latency, finding the source of latency within data processing systems 100A-100N may require a thorough investigation into the components of the systems.

As data processing systems 100A-100N may be susceptible to latency, the performance and user experience may be affected. As the measure of latency increases, the performance and user experience may be expected to decrease. Through the decreasing of performance and user experience, the reliability of data processing systems 100A-100N may be decreased. With sufficient latency they may become incapable of finishing executed processes, data processing systems 100A-100N may become compromised.

To improve the reliability of commands run on data processing systems, the system of FIG. 1 may implement a framework for data processing systems to rely on inference models to identify latency. To identify latency, the inference models may be trained to consider latency data of all possible pathways between applications within a process. After considerations of all possible pathways by the inference model, latency data may be taken by the selected pathways between applications within a process of data processing systems 100A-100N. Comparisons between latency data between the model and data processing systems 100A-100N may be used to identify a negative discrepancy, which illustrates a difference in latencies from both sources. If a difference in latency between both sources is established, a negative communication modifier may be found, which may be the source of the additional latency originating from data processing systems 100A-100N.

To implement the framework, the system of FIG. 1 may include deployment manager 102. Deployment manager 102 may include one or more inference models and a digital twin. The digital twin may be a digital representation of data processing systems 100A-100N. The digital twin may mimic the architecture of, processes performed by, and qualities of data processing systems 100A-100N. For example, the processes may include input and output processes and responses, which may render the digital twin indistinguishable from the real-world counterpart (i.e., data processing systems 100A-100N in this example). Through use of the digital twin, deployment manager 102 may be able to simulate operation of real-world systems to monitor and/or analyze any process like the processes performed by data processing systems 100A-100N. In other words, the digital twin may respond in a manner similar if not the same as that of data processing systems 100A-100N.

As deployment manager 102 may be able to simulate operation of real-world systems, it may run all possible pathways for applications that may be run in data processing systems 100A-100N with the digital twin. In running all possible pathways for applications, it may simulate all output for applications, which may be used as input for subsequent applications along the pathway. In passing output from one application as input for another application, deployment manager 102 may train the inference model to consider latency measurements associated with running chained applications. In training the inference model, consideration of latency measurements may be done for all possible pathways of chained applications. Upon deployment of the inference model by deployment 102 to data processing systems 100A-100N, the inference model may be used in consideration with chained applications in data processing systems 100A-100N. Given a set of applications in data processing systems 100A-100N that are chained, these chained applications may be run by data processing systems 100A-100N. In running the chained applications, latency data may be taken from the output of the chained applications. At the same time, the pathway of the chained applications may also be provided to the inference model. Upon provision of the pathway, the inference model may use the pathway configuration to predict latency data associated with the chained applications in the provided pathway.

Using latency data from running the chained applications in data processing systems 100A-100N and from the inference model, a comparison may be made to demarcate if a difference exists between the latency data. To demarcate if a difference exists between the latency data, a latency threshold may be set by an administrator or subject matter expert. If the difference between both measures of latency data may exceed the latency threshold, then a negative discrepancy may be found to exist. The negative discrepancy may indicate if there exists a difference in time delay for executing the chained applications in data processing systems 100A-100N compared to the prediction from the inference model. If a negative discrepancy may not be found, then the latency data determined from running the chained applications in data processing systems 100A-100N may be determined to be similar to the predication made by the inference model. However, if a negative discrepancy may be found, then the latency data determined from running the chained applications in data processing systems 100A-100N may be determined to be sufficiently different to the predication made by the inference model. The difference in latency data between running the chained applications and the prediction may indicate the presence of a negative communications modifier. The presence of a negative communications modifier may indicate that other processes may be running, or expected processes may not be running as sufficiently as predicted, in the execution of the chained applications that may not be accounted by the inference model. With the presence of the negative communications modifier confirmed, steps can be taken to remediate expected processes or account for unconsidered processes when running for the chained applications in data processing systems 100A-100N.

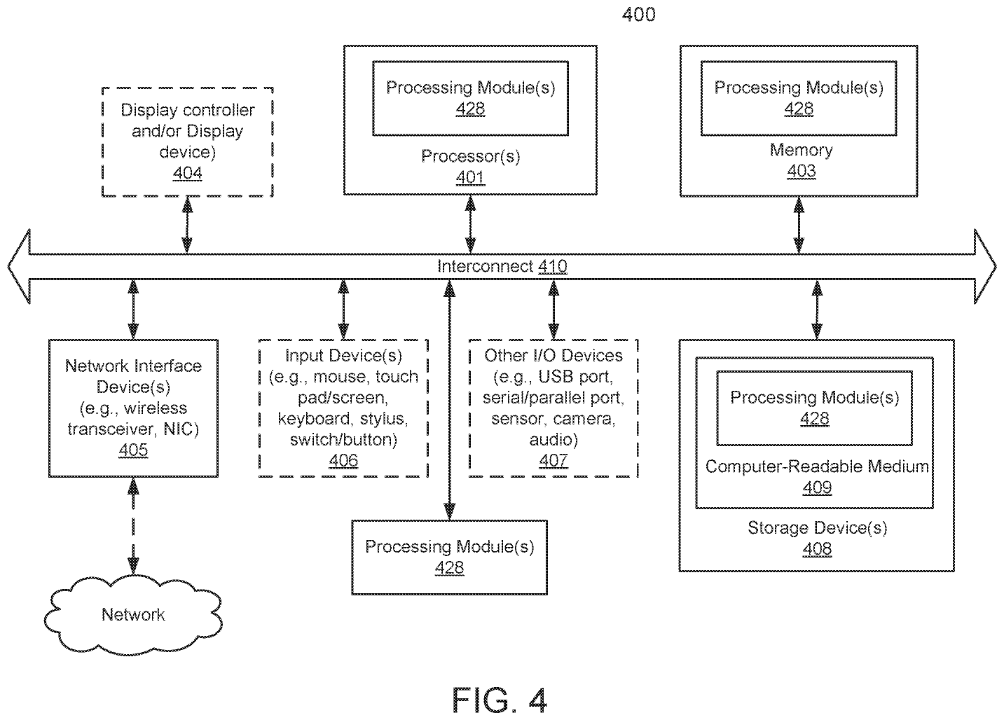

Any of data processing systems 100A-100N and/or deployment manager 102 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 101. In an embodiment, communication system 101 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as included a limited number of specific components, a system in accordance with an embodiment may include fewer, additional, and/or different components than those illustrated therein.

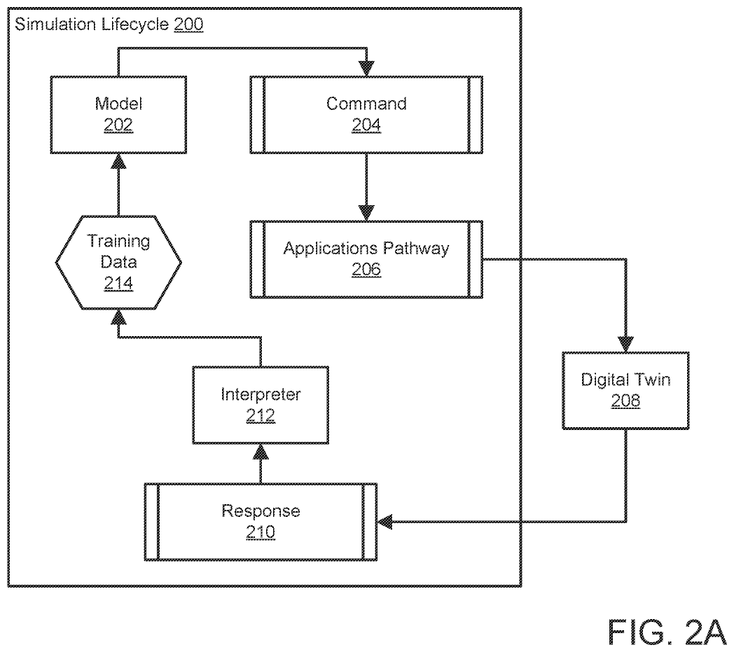

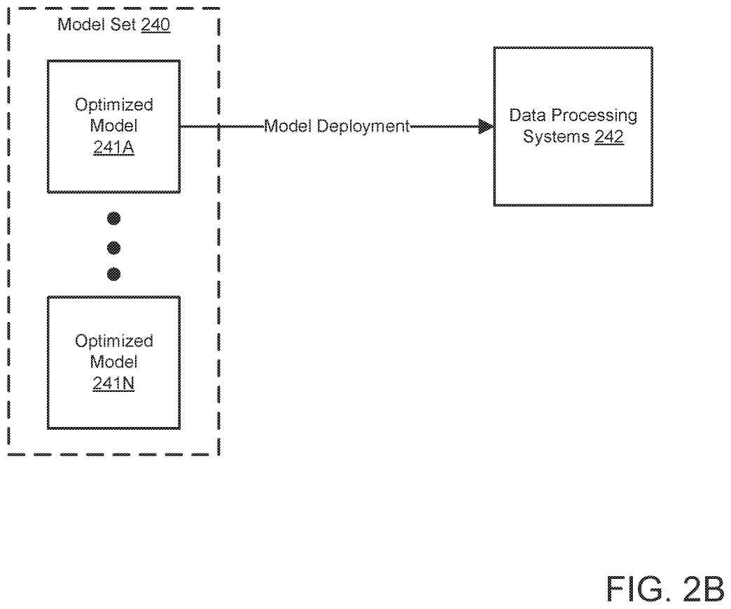

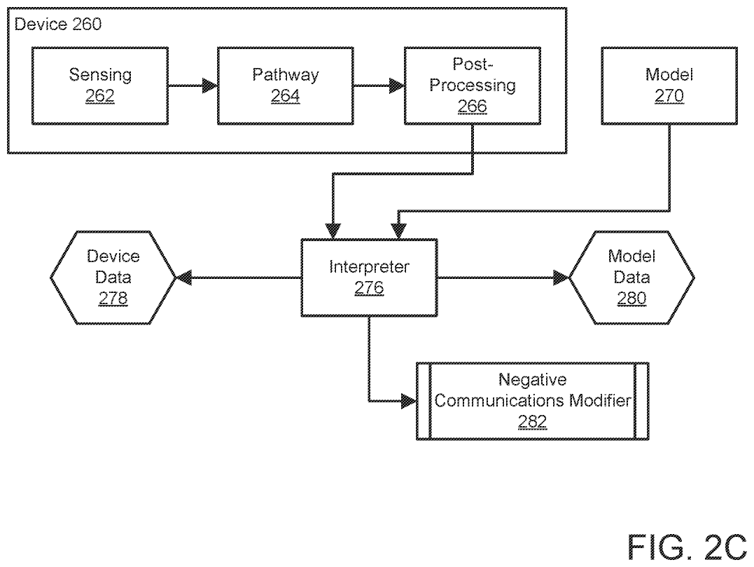

To further clarify embodiments disclosed herein, data flow diagrams are shown in FIG. 2A-2C. These data flow diagrams show flows of data that may be implemented by the system of FIG. 1. In FIG. 2A, simulation lifecycle 200 is illustrated. In FIG. 2B, any of optimized model 241A-241N is being deployed from model set 240 to data processing systems 242. In FIG. 2C, device 260 and model 270 execute processes that produce results from which negative communications modifier 282 may be determined to exist.

Turning to FIG. 2A, a diagram illustrating simulation cycle 200 in accordance with an embodiment is shown. Simulation cycle 200 may regulate the development of model 202 by the deployment manager. The deployment manager may train model 202 to execute command 204 over all possible values for applications pathway 206. For each value of applications pathway 206, command 204 may be executed through simulation on digital twin 208, which may be a digital environment that replicates the real-world system.

Upon completion of execution of command 204, response 210 may give the completion status and raw data from simulation of the executed command 204. Using the completion status and raw data from response 210, interpreter 212 may be tasked with isolating or computing training data 214 from the raw data within response 210. Training data 214 that may be necessary to the training of model 202 may be latency data associated with the simulation of command 204 on digital twin 208.

Once model 202 has absorbed training data 214, simulation lifecycle 200 may repeat with the same value for command 204. Using the same value for command 204, a new value for applications pathway 206 may be applied. In applying a new value for applications pathway 206, a new pathway may be considered through which command 204 may be simulated on digital twin 208. In consideration of a new pathway on digital twin 208, interpreter 212 may compute or isolate latency data in the current step of simulation lifecycle 200 that may differ from latency data in previous steps of simulation lifecycle 200. In isolating or computing varying values of latency data as a function of the step of simulation lifecycle 200, different values of training data 214 may be recorded. In recording different values for training data 214, model 202 may be trained to predict different values of latency data as a function of the value for applications pathway 206 for command 204.

In being trained to predict latency data as a function of applications pathway 206 over simulation lifecycle 200, model 202 may be able to predict latency data for all possible values of application pathway 206 for command 204. Therefore, in consideration of a single applications pathway, model 202 may be expected to predict the corresponding latency data.

Model 202 may be implemented using an inference model. An inference model may be implemented using a machine learning model, a decision tree, naïve bayes model, linear or logistic regression model, kNN model, k-means model, random forest model, and/or support vector machines model.

The machine learning model may be a neural network. The neural network may be trained using supervised learning, unsupervised learning, semi-supervised learning, or reinforcement learning. The learning process may require input of command 204. Command 204 may execute a set of chained applications.

Command 204 may be implemented using one or more data structures that includes instructions needed to run applications pathway 206. Selection of the instructions needed to run applications pathway 206 may stay constant during the training of model 202. In using the same value for command 204, model 202 may be specifically trained to run command 204.

As an example, command 204 may execute a set of operations necessary for a camera to take a photograph of a citizen at some location within a city. Further, upon taking the photograph, the camera may send the photographic data through one of many gateway devices throughout the city which connect to a data center. As there may only be one data center, in which post-processing of photographic data may take place, the city may be large enough that multiple gateway devices may have been established to link all the camera in the city to the data center. Through the establishment of multiple cameras and gateways throughout the city, there may be multiple origination points for the instantiation of photographic data and multiple pathways through which photographic data may be transferred. Although the post-processing of photographic data may occur at the data center, the final destination of every pathway, it may be likely that each camera may need to perform operations, including calibration and sensing actions, before capturing photographic data.

Applications pathway 206 may be implemented using one or more data structures that include instructions of the pathway involved in execution of command 204. The instructions associated with applications pathway 206 may be one of many values. Because applications pathway 206 may be one of many values, command 204 may be run using one of many values of applications pathway 206.

In the example for FIG. 2A, command 204 may execute a set of operations necessary for a camera to take a photograph of a citizen at some location within a city. The camera may be one of numerous cameras. Further, all cameras may be linked to the city data center by numerous gateway devices located throughout the city. As there may be numerous gateway devices throughout the city, there may be numerous pathways through which photographic data may be transferred from a camera to the data center. Since the locations of the gateway devices are all different and the devices are spread throughout the city, the pathways may move around the city in different ways, and the gateway devices may even be near other devices that affect the bandwidth and latency of the data transfer. Therefore, the efficiency of each pathway may need to be modeled in order to understand which gateway devices are associated with the lowest latency for a data transfer of photographic data from a camera to the data center.

Digital twin 208 may be implemented using a one or more processes executing on a data processing system. The processes may simulate the operation of a deployment or other real-world system. The process may include functionality to ingest command 204 and applications pathway 206. With the capability of ingesting command 204 and applications pathway 206, digital twin 208 may provide the software configuration to implement command 204 using applications pathway 206. In providing the software configuration to implement command 204 using application pathway 206, digital twin 208 may be capable of executing command 204 and yielding output data similar to the real-world architecture that it may be intended to emulate.

In the example for FIG. 2A, command 204 may execute a set of operations necessary for a camera to take a photograph of a citizen at some location within a city. All cameras may be linked to the city data center by numerous gateway devices located throughout the city. As digital twin 208 may emulate a city within a digital environment, digital twin 208 may include information on the locations of the gateway devices that link the cameras to the data center. With information on the location of the gateway devices, digital twin 208 may be able to include distance considerations in the determination of latency data. Latency data considerations may also be accounted for by digital twin 208 in camera operations, such as in calibration or sensing steps. Camera operations, in a digital environment associated with digital twin 208, may be simulated by random generation of pictures.

Response 210 may be implemented using one of more data structures that include information on how digital twin 208 responds to implementation of command 204 and applications pathway 206. Information on how digital twin 208 responds may include any photographic data and metadata from the operation of a camera. In addition to operation of the camera, response 210 may include metadata from applications pathway 206 that was implemented to transfer photographic data to a data center.

In the example for FIG. 2A, command 204 may execute a set of operations necessary for a camera to take a photograph of a citizen at some location within a city. Response 210 may include generation of random photographs in an effort to simulate a camera taking real-world photographs. Camera operations associated with generation of photographs may be estimated. Given applications pathway 206, response 210 may include metadata concerning data transfer, including latency data, for the pathway, and activity logs, event messages, or metadata for gateway devices along applications pathway 206.

Interpreter 212 may be implemented using a process that may be able to read any event messages, activity logs, or metadata that may comprise response 210. The goal of reading response 210 may be to isolate or compute latency data relating to the utilization of applications pathway 206 utilized by command 204. In isolating or computing latency data, interpreter 212 may clean latency data for the training of model 202.

In the example for FIG. 2A, command 204 may execute a set of operations necessary for a camera to take a photograph of a citizen at some location within a city. Simulation of the city by digital twin 208 and implementation of command 204 along applications pathway 206 may have yielded photographic data and metadata from operation of a camera. As well, digital twin 208 may have yielded activity logs, event messages, or metadata for gateway devices along applications pathway 206. As latency data may be required as training data 214, interpreter 212 may extract the necessary data by reading the results of camera operations and gateway device operations. Interpreter 212 may know to isolate latency data by keyword or foreknowledge of database location. Once interpreter 212 captures latency data, interpreter 212 makes available the latency data as training data 214 for model 202.

Training data 214 may be implemented using one of more data structures that include information to be utilized in the training of model 202. In being utilized as training data 214, the data may have been deemed appropriate by interpreter 212 to be extracted from response 210. In being extracted from response 210, training data 214 may be the response of simulation of command 204 with applications pathway 206 in digital twin 208.

In the example for FIG. 2A, command 204 may execute a set of operations necessary for a camera to take a photograph of a citizen at some location within a city. As isolated or computed from the results of the simulation by digital twin 208, training data 214 may include latency data on the data transfer of photographic data from a camera through one or more gateway devices to a data center. As the data transfer involves this path from the camera to the data center, the latency data may be associated with this pathway, which may be applications pathway 206. As training data 214, which may include latency data, may be associated with application pathway 206, the ingestion of training data 214 by model 202 implies that model 202 may vary its predictions as a function of applications pathway 206.

As simulation lifecycle 200 may repeat, the value for applications pathway 206 may be varied with each simulation cycle. As the value for applications pathway 206 may vary, new values for training data 214 may be extracted from response 210 and may be further ingested by model 202. Completion of simulation lifecycle 200 may yield model 202 with the capability to predict latency data for any applications pathway 206 run used by command 204.

Thus, as shown in FIG. 2A, a system in accordance with an embodiment may identify a simulation lifecycle in which model 202 may be trained. In training the inference model, all possible values for applications pathway 206 for command 204 may be simulated with digital twin 208. In simulating with digital twin 208, values for latency data may be used as training data 214 for model 202.

Turning to FIG. 2B, a diagram illustrating deployment of optimized model 241A-241N in accordance with an embodiment is shown. Optimized model 241A-241N may be elements of model set 240, the models of which may have been optimized within simulation lifecycles. The model within optimized model 241A-241N that may exhibit the best performance or accuracy may be selected for deployment to data processing systems 242. Once deployed to data processing systems 242, the deployed model from optimized model 241A-241N may be used in the prediction of latency data alongside real-world processes.

Model set 240 may be a collection of optimized model 241A-241N inference models. The collection of optimized model 241A-241N may include models optimized to varying performance criteria.

Optimized model 241A-241N may be implemented using an inference model. An inference model may be implemented using a machine learning model, a decision tree, naïve bayes model, linear or logistic regression model, kNN model, k-means model, random forest model, and/or support vector machines model. The machine learning model may be a neural network. The neural network may be trained using supervised learning, unsupervised learning, semi-supervised learning, or reinforcement learning. Training of optimized model 241A-241N may yield different models because of variations in input data and configuration variables that are internal to the models. Also, because of the variations in input data and configuration variables, performance of optimized model 241A-241N may also vary. As the performance of optimized model 241A-241N may vary, error analysis may need to be performed with optimized model 241A-241N to determine which model may be fit for deployment.

From the example in FIG. 2A, a model was constructed to predict latency data associated with photographic data being passed from a camera through one of many gateway devices to a data center for post-processing. The gateway devices may be scattered around locations within a city, many possible pathways exist through which to pass data. The model may be expected to predict latency data of a pathway through training of the model, a process which may require iterating computations of latency data over all possible pathways. In addition to considering computations of latency data over all possible pathways, model construction may be dependent on modifications of the training data and configuration parameters of the model. Parameters of the model that might affect fidelity of the model may include learning rate, epochs, number of iterations in an epoch, hidden layers in a neural network, activation rate in each layer, and choice of optimization algorithm. As a result of variation in parameters such as these, the number of models within model set 241 may be many. Therefore, performance measurements may be done with each model within optimized model 241A-241N to determine to determine the fitness of the model before deployment to data processing system 242.

Data processing systems 242 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Using the example from FIG. 2A, data processing systems 242 may utilize a model from optimized model 241A-241N. In utilizing a model from optimized model 241A-241N, data processing systems 242 may be tasked with computing latency data from real-world processes related to the transfer and post-processing of photographic data from a camera through multiple pathways of gateway devices to a data center. In computing latency data from real-world processes, data processing systems 242 may compare latency data from real-world processes to latency data from optimized model 241A-241N predictions. In making comparisons, data processing systems 242 may differences in latency data that originate from real-world issues with latency data that may not be predictable by optimized model 241A-241N. In finding differences in latency data between real-world processes and model prediction, data processing systems 242 may be responsible for the reporting and remediation of real-world effects on latency data.

Thus, as shown in FIG. 2B, a system in accordance with an embodiment may illustrate deployment of optimized model 241A-241N. Optimized model 241A-241N may be contained in model set 240. Within model set 240, each model for optimized model 241A-241N may vary in performance and configuration. The most optimal performing and/or optimally configured model of optimized model 241A-241N may be deployed to data processing systems 242. As data processing systems 242 may be responsible for computing latency data for real-world processes, data processing systems 242 may utilize optimized model 241A-241N for model prediction of latency data. In using model prediction, data processing systems 242 may use the deployed model of optimized model 241A-241N to help isolate, report, and remediate real-world effects on latency data.

Turning to FIG. 2C, a diagram illustrating a sequence of actions from device 260 and model 270 in accordance with an embodiment is shown. The sequence of actions from device 260, in a real-world setting, and model 270, in a predictive capacity, may represent a comparison between the work done by both entities. In the comparison of work done by both entities, the comparison may result in negative communications modifier 282, which may further specify differences in latency data between device data 278 and model data 280.

To obtain negative communications modifier 282, device 260 may execute a sequence of actions in the real world. The example from FIG. 2A may be employed in which device 260 may be a camera, connected to numerous gateway devices in a city, all of which connect to a data center. In the previous figures, the photographic capture by a camera and data transfer through the gateway devices may have been simulated by a digital twin. In this figure, device 260, a camera, may exist in the real world. In the real world, the camera may execute sensing 262, in which a photograph is taken by the camera. Next, in pathway 264, the photographic data may be transferred through the real-world gateway devices. Upon arrival of the photographic data to a data center, during post-processing 266, the photographic data may be processed for information.

Unlike in FIG. 2A, where these actions may have been simulated by a digital twin, in this example in FIG. 2C, the steps for device 260 may take place in the real world. Therefore, as sensing 262, pathway 264, and post-processing 266 may take place in the real world, the hardware associated with these steps may be subject natural degradation of the components, including the camera, wires, enclosures. Natural degradation may include exposure to weather, such as rain, snow, or wind, which may over time degrade the material of the hardware. Additionally, the hardware and software associated with sensing 262, pathway 264, and post-processing 266 may be subject to malicious action by bad actors. In being subject to malicious action, bad actors may tamper with the hardware, disable the device, or hack the software on the device in order to gain control. As a result of natural degradation or malicious action, device 260 may experience latency issues in the transfer of photographic data and contribute to the decreased quality of device response 272.

In contrast with the fact that device 260 may function in the real world, model 270 may be run to mimic the functionality of device 260. In mimicking the functionality of device 260, model 270 may utilize the same software and pathway 264 as device 260 but considerations of natural degradation or malicious action on the hardware of device 260 may not be present. Thus, as model 270, similar to model 202 in FIG. 2A, was designed to predict latency data for the process involved in device 260, model 270 may not be capable of latency resulting from the natural degradation or malicious action upon device 260. Therefore, differences may be present in device response 272 and model response 274 due to the natural degradation or malicious actions that device 260 may experience.

As device response 272 and model response 274 may be given by device 260 and model 270, respectively, interpreter 276 may be tasked cataloging the data between device 260 and model 270. In cataloging the data between device 260 and model 270, interpreter 276 may be tasked specifically with noting the differences in latency between device 260 and model 270. The latency data for device 260 may be cataloged from interpreter 276 as device data 278. Similarly, the latency data for model 270 may be cataloged from interpreter 276 as model data 280. Any differences between device data 278 and model data 280 may be termed as a negative discrepancy. If a negative discrepancy may be found, interpreter 276 may determine the source of the negative discrepancy, called the negative communications modifier. From identification of the negative communications modifier, attempts can be made to remedy the cause of or the response by device 260 to the negative communications modifier.

Device 260 may be a process involving sensing 262, pathway 264, and post-processing 266. As it may entail multiple steps, device 260 may be intended to capture the behavior of a real-world device. As it is intended to capture the behavior of a real-world device, device 260 may entail multiple processes that regulate its function.

Sensing 262 may be implemented as a process relating to the capture of photographic data by a real-world camera. The real-world camera may be part of a network of cameras. Each camera with the network may be responsible for monitoring activities. Activities may be recorded using features on device 262 that may augment sensory capabilities in order to identify entities or locations.

Continuing with the example, device 260 may be a real-world camera that is part of a network of cameras within a city. Cameras may be employed to monitor activities of people and activities. In monitoring activities, photographic data may be periodically taken. When photographic data may be captured, the photographic data may be sent to a data center through one of many pathways comprised of gateway devices throughout the city network.

Pathway 264 may be implemented as a process relating to the configuration of a network through which data may be transferred. As it relates to a network, there may be numerous pathways through which data may be transferred. As there may be numerous pathways, pathway 264 may be one pathway that can be specified for data transfer.

Continuing with the example, device 260 may have captured photographic data during the step called sensing 262. Further, device 260 may have performed actions during sensing 262 to render the photographic data ready for transfer. Given the proximity of device 260 to nearest-neighbor gateway devices, device 260 may have selected pathway 264 by which to send the photographic data to the data center. Latency with the data transfer through the gateway devices may exist due to any degradation or lack of upkeep of the gateway devices. Degradation of the gateway devices may include impact from bad weather or malicious actions to destabilize the hardware of the gateway devices.

Post-processing 270 may be implemented as a process relating to the modifications in the photographic data to ascertain human-readable data. Modifications to the photographic data may transpire using various types of software and hardware. Through using various types of software and hardware, the identification of entities within photographic data and metadata, including latency data associated with data transfer through the gateway devices, may be obtained.

Continuing with the example, device 260 may have captured photographic data during the step called sensing 260 and transferred it through pathway 264 to a data center. Upon receiving the photographic data, the data center may perform post-processing 266 on the data. Performance of post-processing 266 on the data may have the purpose of identification of entities within the photographic data. Included with the data may be metadata, which may contain latency data associated with the data transfer through gateway devices from the camera.

Model 270 may be implemented using an inference model. An inference model may be implemented using a machine learning model, a decision tree, naïve bayes model, linear or logistic regression model, kNN model, k-means model, random forest model, and/or support vector machines model.

The machine learning model may be a neural network. The neural network may be trained using supervised learning, unsupervised learning, semi-supervised learning, or reinforcement learning. The learning process for model 270 may have entailed learning how to predict latency data for a given pathway, similar to pathway 264.

Continuing with the example, device 260 may have captured photographic data during the step called sensing 260 and transferred it through pathway 264 to a data center. At the data center, the photographic data may have been post-processed for human-readable information. Additionally, latency data associated with the data transfer through gateway devices from the camera may have been obtained from the metadata. Alongside this process, model 270 may predict latency data associated with pathway 264, as it was trained to do from simulation lifecycle 200 in FIG. 2A. Comparison of latency data between device 260 and model 270 may be facilitated by interpreter 276.

Interpreter 276 may be implemented as a process concerning the identification and parsing of latency data. As it may be implemented to identify and parse latency data, interpreter 276 may understand how to read data incoming from device 260 and model 270. In knowing how to read data from device 260 and model 270, interpreter 276 may be capable to reformat the data in a readable format to export it as device data 278 and model data 280. In addition to reading data from device 260 and model 270, interpreter 276 may contain functionality to identify a negative discrepancy and the logic to determine negative communications modifier 282.

Continuing with the example, device 260 may have yielded post-processed photographic data with metadata that include latency data. As well, model 270 may have used pathway 264 to predict latency data. Interpreter 276 may be capable of reading the results of both device 260 and model 270. Further, interpreter 276 may read the metadata to find latency data for both device 260 and model 270, or may need to compute latency data for both entities. The latency data for device 260 and model 270 may be exported from interpreter 276 as device data 278 and model 280, respectively. If interpreter 276 may find differences in the latency data between device 260 and model 270, then interpreter 276 may find a negative discrepancy between both entities. In this case, the negative discrepancy may illustrate that model 270 may not be accurately predicting latency for pathway 264 that was used by device 260. In addition to determining the presence of a negative discrepancy, interpreter 276 may contain the capabilities to determine the source of the negative discrepancy. The source of the negative discrepancy may be called the negative communications modifier. Interpreter 276 may contain information about the hardware or condition of the gateway devices along pathway 264 to isolate the source of one or more reasons for the negative communications modifier.

Negative communications modifier 282 may implemented as a data structure that contains information on the source of a negative discrepancy between device 260 and model 270. The negative discrepancy between device 260 and model 270 may be the result of differences in perception of pathway 264. As model 270 may only account for the digital configuration of pathway 264 and not the real-world condition of pathway 264, model 270 may be limited in the modeling of pathway 264 for prediction of latency data. The differences in digital configuration and the real-world condition of pathway 264 may be contained in negative communication modifier 282, as these differences may be the source of the negative discrepancy in data between device 260 and model 270.

Continuing with the example, a negative discrepancy may have been found between latency data for photographic data taken by device 260 and modeled by model 270. The presence of the negative discrepancy in the latency data between both entities may mark the presence of negative communications modifier 282. In this example, negative communications modifier 282 may be related to natural degradation or malicious action brought upon one or more gateway devices. In having natural degradation or malicious action brought upon one or more gateway devices, latency data associated with pathway 264 may be modified. This modification may be evident in the real-world application of device 260 but not in the digital representation by model 270. However, interpreter 276 may be capable to examine latency data between both entities and identify negative communications modifier 276.

Device data 278 may be implemented as a data structure concerning latency data associated with device 260. The latency data associated with device 260 may be parsed or computed by interpreter 276 from post-processing 266. As latency data associated with device 260, it may be used in the determination of a negative discrepancy with model data 280.

Continuing with the example, device data 278 may include latency data that was parsed or computed by interpreter 276. The latency data may take into account any natural degradation or malicious action taken upon the gateway devices along pathway 264. These conditions may not be present in the latency data that is contained within model data 280.

Model data 280 may be implemented as a data structure concerning latency data associated with model 270. The latency data associated with model 270 may be parsed or computed by interpreter 276 from data retrieved from model 270. As latency data associated with model 270, it may be used in the determination of a negative discrepancy with device data 278.

Continuing with the example, model data 280 may include latency data that was parsed or computed by interpreter 276. The latency data may only account for a digital representation of the gateway devices along pathway 264. Therefore, model data 280 may not account for the real-world conditions associated with pathway 264.

Thus, as shown in FIG. 2C, a system in accordance with an embodiment may illustrate a sequence of actions between device 260 and model 270 toward the identification of negative communications modifier 282. Device 280 may demonstrate application of a real-world device along pathway 264 and model 270 may demonstrate application of a digital representation of device 280. Interpretation of the corresponding output may yield the latency data from device data 278 and model data 280. A negative discrepancy, which may note a difference between device data 278 and model data 280, may be found. The source of the negative discrepancy may be negative communications modifier 282.

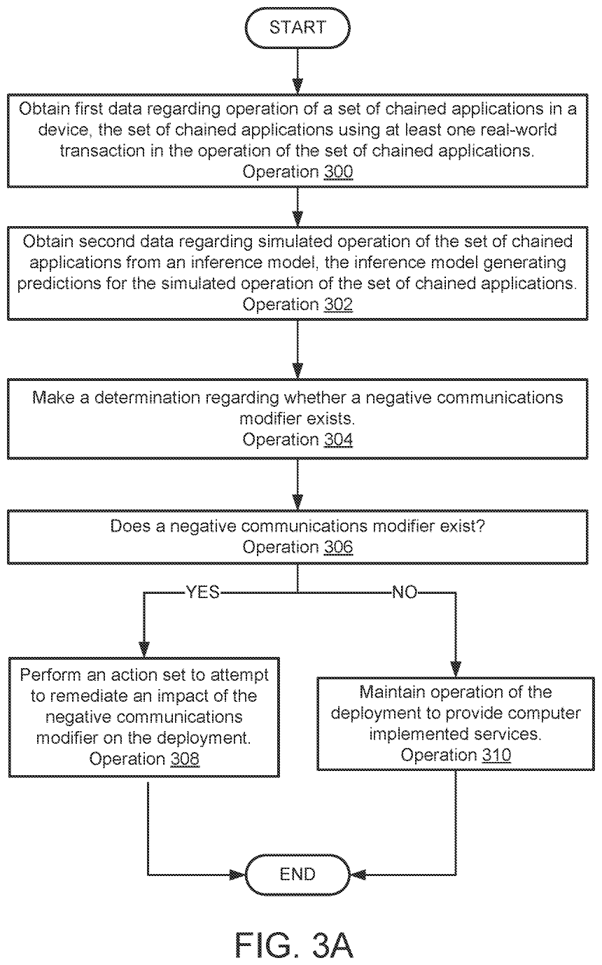

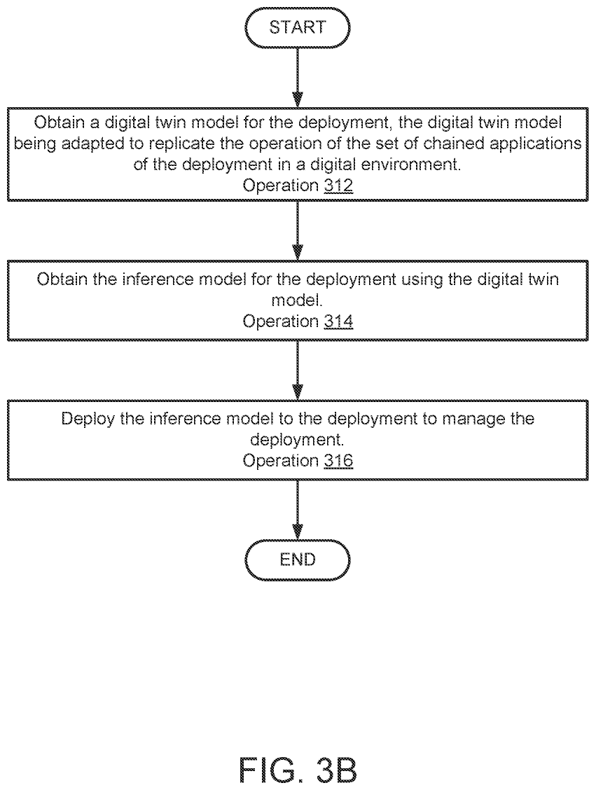

As discussed above, the components of FIG. 1 may perform various methods to determine the presence of a negative communications modifier for the applications pathway that may be utilized by an inference model and a real-world device. FIGS. 3A-3B illustrate methods that may be performed by the components of FIG. 1.

Prior to the operations in FIG. 3A, the operations of FIG. 3B may be performed.

Turning to FIG. 3A, a flow diagram illustrating the determination of the presence of a negative communications modifier is shown. The operation may be performed, for example, by an public or private data system, provided by the same location as a data processing system or by a cloud service.

At operation 300, first data may be obtained regarding operation of a set of chained applications in a device of the deployment, the set of chained applications using at least one real-world transaction in the operation of the set of chained applications. The first data may be obtained by executing the set of chained applications in a device and processing the latency data of the set of chained applications from the device into a readable format.

At operation 302, second data may be obtained regarding simulated operation of the set of chained applications from an inference model, the inference model generating predictions for the simulated operation of the set of chained application. The second data may be obtained by simulating the set of chained applications with an inference model and processing the latency data of the set of chained applications from the simulation into a readable format.

At operation 304, a determination may be made regarding whether a negative communications modifier exists. A determination may be made by comparing the latency data of the set of chained applications from the inference model and the device and quantifying if a difference in the latency data exists greater a pre-determined latency threshold.

In a first instance of the determination where the negative communication modifier exists, at operation 308, an action set is performed to attempt to remediate an impact of the negative communication modifier on the deployment. An action set may be performed by implementing new procedures to the hardware or software configuration of the device.

In a second instance of the determination where the negative communication modifier does not exist, at operation 310, operation of the deployment may be maintained to provide computer implemented services. Operation of the deployment may be maintained by not implementing new procedures to the hardware or software configuration of the device that might alter its function.

The method may end following operation 310.

Turning to FIG. 3B, a flow diagram illustrating the preparation steps involving the inference model and the digital twin is shown. The preparation steps may be run by the deployment manager.

At operation 312, the digital twin may be obtained for the deployment, the digital twin model being adapted to replicate the operation of the set of chained applications of the deployment in a digital environment. The digital twin may be obtained by reading an instance from a storage device, or constructing an instance configured to operate the set of chained applications of the deployment.

At operation 314, the inference model may be obtained for the deployment using the digital twin model. The inference model may be obtained by reading an instance from a storage device, or constructing an instance configured to operate a command with the set of chained applications of the deployment.

At operation 316, the inference model may be deployed to the deployment to manage the deployment. The inference model may be deployed by finishing training of the inference model with the set of chained applications in the deployment manager and releasing the inference model from the deployment manager to be set to run in the deployment.

The method may end following operation 316.

Any of the components illustrated in FIGS. 1-3B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing a deployment, the method comprising:
obtaining first data regarding operation of a set of chained applications in a device of the deployment, the set of chained applications using at least one real-world transaction in the operation of the set of chained applications;
obtaining second data regarding simulated operation of the set of chained applications from an inference model, the inference model generating predictions for the simulated operation of the set of chained application;
making a determination regarding whether a negative communications modifier existing in the deployment based on the first data and the second data; and
in a first instance of the determination where the negative communication modifier exists:
performing an action set to attempt to remediate an impact of the negative communication modifier on the deployment;
in a second instance of the determination where the negative communication modifier does not exist:
maintaining operation of the deployment to provide computer implemented services.

2. The method of claim 1, further comprising:
prior to obtaining the first data and the second data:
obtaining a digital twin model for the deployment, the digital twin model being adapted to replicate the operation of the set of chained applications of the deployment in a digital environment;
obtaining the inference model for the deployment using the digital twin model; and
deploying the inference model to the deployment to manage the deployment.

3. The method of claim 2, wherein obtaining the inference model comprises:
identifying a type of inference model based on applications of the deployment that are chained together to obtain the set of chained applications; and
generating an instance of the type of the inference model.

4. The method of claim 3, wherein identifying the type of inference model comprises:
identifying the set of chained applications for the inference model;
identifying an input and output of each application in the set of chained applications; and
setting application pathways between the set of the applications so that output of one application is input of a valid type for another application.

5. The method of claim 4, wherein generating the instance of the type of inference model comprises:
selecting a process that randomizes the application pathways of the set of chained applications;
identifying a set of first operations resulting from execution of the set of chained applications with the inference model that uses the randomized application pathways; and
obtaining training data based on the set of first operations of the set of chained applications.

6. The method of claim 1, wherein obtaining the first data regarding the operation of the set of chained applications comprises:
identifying a duration of time for performance of the operation of the set of chained applications, the operation of the set of chained applications being defined by a pre-selected pathway of pathways through applications hosted by the deployment.

7. The method of claim 6, wherein obtaining the second data regarding simulated operation of the set of chained applications from the inference model comprises:
ingesting the pre-selected pathway into the inference model to obtain a prediction for the duration of time for the performance of the operation of the set of chain applications.

8. The method of claim 7, wherein making the determination comprises:
obtaining a latency threshold for the duration of time;
performing a comparison of the duration of time and the prediction for the duration of time using the latency threshold; and
in an instance of the comparison where the duration of time exceeds the prediction for the duration of time and the latency threshold:
identifying that a negative communication modifier exists.

9. A non-transitory machine-readable medium having instructions stored therein, which when executed by a processor, cause the processor to perform operations for securing a deployment, the operations comprising, the operation comprising:
obtaining first data regarding operation of a set of chained applications in a device of the deployment, the set of chained applications using at least one real-world transaction in the operation of the set of chained applications;
obtaining second data regarding simulated operation of the set of chained applications from an inference model, the inference model generating predictions for the simulated operation of the set of chained application;
making a determination regarding whether a negative communications modifier existing in the deployment based on the first data and the second data; and
in a first instance of the determination where the negative communication modifier exists:
performing an action set to attempt to remediate an impact of the negative communication modifier on the deployment;
in a second instance of the determination where the negative communication modifier does not exist:
maintaining operation of the deployment to provide computer implemented services.

10. The non-transitory machine-readable medium of claim 9, further comprising:
prior to obtaining the first data and the second data:
obtaining a digital twin model for the deployment, the digital twin model being adapted to replicate the operation of the set of chained applications of the deployment in a digital environment;
obtaining the inference model for the deployment using the digital twin model; and
deploying the inference model to the deployment to manage the deployment.

11. The non-transitory machine-readable medium of claim 10, wherein obtaining the inference model comprises:
identifying a type of inference model based on applications of the deployment that are chained together to obtain the set of chained applications; and
generating an instance of the type of the inference model.

12. The non-transitory machine-readable medium of claim 11, wherein identifying the type of inference model comprises:
identifying the set of chained applications for the inference model;
identifying an input and output of each application in the set of chained applications; and
setting application pathways between the set of the applications so that output of one application is input of a valid type for another application.

13. The non-transitory machine-readable medium of claim 12, wherein generating the instance of the type of inference model comprises:
selecting a process that randomizes the application pathways of the set of chained applications;
identifying a set of first operations resulting from execution of the set of chained applications with the inference model that uses the randomized application pathways; and
obtaining training data based on the set of first operations of the set of chained applications.

14. The non-transitory machine-readable medium of claim 9, wherein obtaining the first data regarding the operation of the set of chained applications comprises:
identifying a duration of time for performance of the operation of the set of chained applications, the operation of the set of chained applications being defined by a pre-selected pathway of pathways through applications hosted by the deployment.

15. A data processing system, comprising:
a processor; and
a memory coupled to the processor to store instructions, which when executed by the processor, cause the processor to perform operations for securing a deployment, the operations comprising:
obtaining first data regarding operation of a set of chained applications in a device of the deployment, the set of chained applications using at least one real-world transaction in the operation of the set of chained applications;
obtaining second data regarding simulated operation of the set of chained applications from an inference model, the inference model generating predictions for the simulated operation of the set of chained application;
making a determination regarding whether a negative communications modifier existing in the deployment based on the first data and the second data; and
in a first instance of the determination where the negative communication modifier exists:
performing an action set to attempt to remediate an impact of the negative communication modifier on the deployment;
in a second instance of the determination where the negative communication modifier does not exist:
maintaining operation of the deployment to provide computer implemented services.

16. The data processing system of claim 15, further comprising:
prior to obtaining the first data and the second data:
obtaining a digital twin model for the deployment, the digital twin model being adapted to replicate the operation of the set of chained applications of the deployment in a digital environment;
obtaining the inference model for the deployment using the digital twin model; and
deploying the inference model to the deployment to manage the deployment.

17. The data processing system of claim 16, wherein obtaining the inference model comprises:
identifying a type of inference model based on applications of the deployment that are chained together to obtain the set of chained applications; and
generating an instance of the type of the inference model.

18. The data processing system of claim 17, wherein identifying the type of inference model comprises:
identifying the set of chained applications for the inference model;
identifying an input and output of each application in the set of chained applications; and
setting application pathways between the set of the applications so that output of one application is input of a valid type for another application.

19. The data processing system of claim 18, wherein generating the instance of the type of inference model comprises:
selecting a process that randomizes the application pathways of the set of chained applications;
identifying a set of first operations resulting from execution of the set of chained applications with the inference model that uses the randomized application pathways; and
obtaining training data based on the set of first operations of the set of chained applications.

20. The data processing system of claim 15, wherein obtaining the first data regarding the operation of the set of chained applications comprises:
identifying a duration of time for performance of the operation of the set of chained applications, the operation of the set of chained applications being defined by a pre-selected pathway of pathways through applications hosted by the deployment.
